(19) United States
(12) Patent Application Publication
(10) Pub. No.: US 2010/0190526 A1
(43) Pub. Date: Jul. 29, 2010

(54) Cellular Telephone Using Multiple Accounts

(75) Inventor: Laurence Victor Marks, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 12/360,874

(22) Filed: Jan. 28, 2009

(51) Int. Cl. H04B 1/38

(52) U.S. Cl. 455/558

(57) ABSTRACT

A cellular telephone instrument having a plurality of SIM card slots has a plurality of SIM cards inserted, each of the SIM cards identifying a corresponding one service identity distinct from service identities identified by others of said SIM cards, and a control element in the instrument enabling selection of one of the plurality of service identities and effectuating operation of the instrument under the selected service identity.

### FIELD AND BACKGROUND OF INVENTION

This invention relates to cellular telephones and cellular telephone service. Cellular telephones have become a ubiquitous part of daily life. They have become essential to many business and governmental professionals. Many of such individuals, in order to manage separate accounts or identities, may use or carry multiple telephone instruments.

For example, an elected official may be under legal restraints regarding the nature of calls which may be made from a particular telephone. Such an official may use one telephone for calls in an official government capacity; another for calls to a re-election committee; and another for purely personal use. Additionally, a user of multiple telephones may wish to distinguish among varying ways that a telephone is answered, or answering services are employed. An entrepreneur may need differing telephones for different businesses, as well as a telephone for purely personal use. The only solution prior to this invention has been to carry multiple telephones.

### SUMMARY OF THE INVENTION

The present invention provides a new and different solution by providing for multiple accounts to be supported on a single telephone instrument. This is done with no or minimal changes in the existing network infrastructure, The invention allows registration on multiple accounts and roaming on those accounts on the single instrument.

In realizing the purposes of this invention, the enabled telephone will display different screens depending on which account is active on the telephone. The enabled telephone will support call waiting functions across the multiple accounts; call hold across the multiple accounts (permitting a call being conducted in one account to be held while a call is taken or initiated on another account enabled on that single instrument). A call being conducted on one account may be conferenced with a call being conducted on another account enabled on the single instrument. Calls received in different account may be distinguished by differing ring tones.

### BRIEF DESCRIPTION OF DRAWINGS

Some of the purposes of the invention having been stated, others will appear as the description proceeds, when taken in connection with the accompanying drawings, in which:

FIG. 1 shows a prior art cellular telephone with one SIM (Subscriber Information Module) socket;

FIG. 2 shows a multiple account cellular telephone with multiple SIM sockets;

FIG. 3 shows a screen display of a prior art cellular telephone receiving an incoming call;

FIG. 4 shows a screen display of a multiple account cellular telephone receiving an incoming call;

FIG. 5 shows the dialing directory of a multiple account cellular telephone;

FIG. 6 shows the dialog presented after a user has entered a number sequence on the keypad of the multiple account cellular telephone and pressed Send; and

FIG. 7 shows the dialog presented after a user causes data services to be initiated.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Conceptually, the idea of a cellular telephone which supports multiple accounts concurrently is easy to grasp. Reduction to practice is a bit more difficult. It is appealing to consider a cellular telephone which can perform this function with no changes to the infrastructure. Creating such a device presents problems.

Transmission timing is critical for cellular telephones using both schemes commonly used in the United States. Global System for Mobile communications (GSM) phones are assigned a particular time slot for sending and receiving data. Code Division Multiple Access (CDMA) phones don't use time slots but must be “spread” by a precisely timed channel code. A single cellular phone which attempted to emulate two phones would have difficulty if assigned timings conflicted. It might be possible to build a mobile telephone with two or more separate non-interfering transmitter/receivers, but a preferred approach appears to be to involve the infrastructure and use common transmit and receive physical channels to carry logical information for two or more phone instances. This latter approach may lead to the requirement that the multiple accounts be with the same carrier.

Cellular telephone systems operate with physical and logical channels. Physical channels have a unique frequency, code, or transmission schedule. Logical channels are each used for a unique purpose. Each logical channel is mapped onto a physical channel. The multi-account phone of this invention is preferably implemented using the same set of physical channels used for single-account phones, but employing a separate set of logical channels for each account.

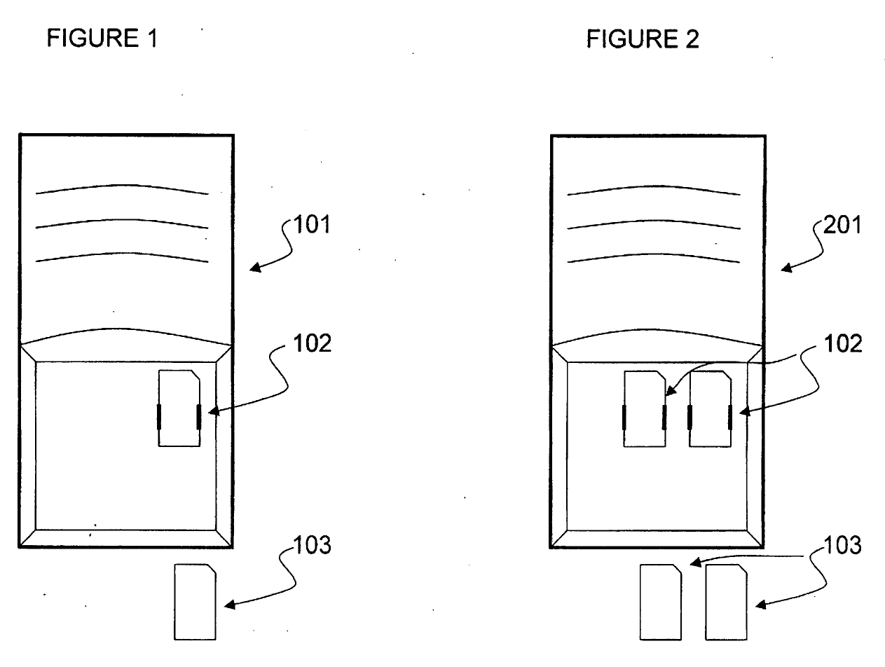

As in the case of current cellular telephones, strict measures are necessary to assure privacy and security, to minimize the opportunity for “cloning” telephones, and to reliably authenticate the telephone. Current telephones utilize a Subscriber Identification Module (SIM) for this purpose. The SIM card carries encrypted data identifying the associated account. Typically the SIM sockets are located beneath the battery to assure that the battery is not in place while the SIM is being inserted or extracted. In FIG. 1, the cellular telephone is indicated at 101, the SIM socket at 102, and the SIM card at 103. A multi-account cellular telephone would utilize multiple SIMs as shown in FIG. 2. In the exemplary multiple-account cellular telephone 201, two SIM sockets 102 are provided, to carry two SIMs 103. The data stored on the two SIM cards identifies two separate accounts.

Multi-account phone procedures are described for each of the following events:

1. Initialization

2. Incoming Call

3. Call Waiting

4. Conference (Three-way) Call

5. Outgoing Call

6. Voicemail

7. Call Log

8. Text Messaging

9. Web browsing, internet access, data services

### Initialization

Initialization for the multiple account cellular telephone of this invention works as it does in single-account phones. The phone would monitor the Synchronization Channel (physical channel SCH), make a request on the Random Access Channel (physical channel RACH), and receive a channel assignment response on the Acquisition Indicator Channel (physical channel AICH).

Once channel assignments and power adjustments have taken place on the physical channels, registration can take place for each account. In current cellular systems, a Home Location Register database is updated with the location (current cell) of the mobile phone so incoming calls may be routed, and a Visiting Location Register associated with the current cell site is updated with subscriber information from the Home Location Register so user call privileges and settings may be observed. In the inventive multiple-account cellphone, this process takes place for each installed SIM, each corresponding to a different account. Information from each of the SIMs is used to register a different account in succession. Different Called Party BCD Numbers for incoming calls and different Calling Party BCD Numbers for outgoing calls (as described in ETSI standard GSM 04.08, incorporated herein by reference) or different radio channels may be used to distinguish accounts. Subsequent messages (e.g., Call Progress, Release) will contain a Transaction Identifier which the multi-account phone uses to determine to which active call the message applies. Alternatively the messages could arrive on different logical radio channels related to the respective calls. The settings may be different for each account. For example, one account could be set to transfer incoming calls to voicemail if there is no answer, while another could be set to forward them to an office line. Roaming permissions may also be different for each account.

### Incoming Call

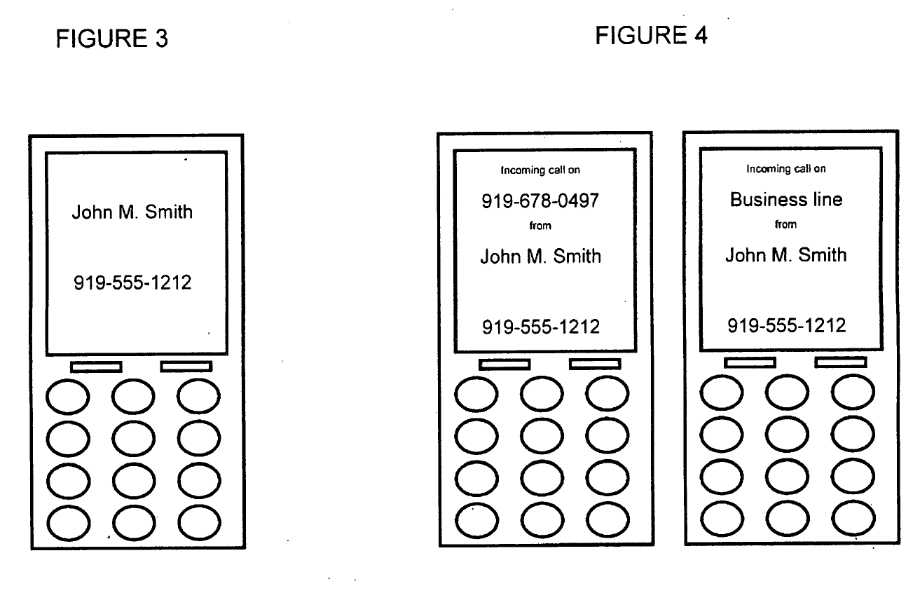

An incoming call to the multi-account phone is handled similarly to that for a single-account phone (Call Setup, Connect, etc. as described in the ETSI GSM 04.08). A call offered to a single-account usually identifies the calling party's name or number or both, as shown in FIG. 3. When a call is offered to the multi-account phone, the user must be alerted as to which account is being called in order that he may offer the proper greeting. The user may set different ring tones or vibrations for each account. The screen should identify which account is being called by use of the phone number, user-settable text indicia or screen background color or combinations thereof as shown in FIG. 4. The call is accepted, maintained, and terminated in manner similar to that of a conventional single-account phone.

### Call Waiting

A mobile phone may be offered an additional call while a current call is active. In the case of the multi-account phone, the call being offered may be on the same account or a different account. The incoming Call Setup message indicates the call specifics. The multi-account phone returns an Alerting message and offers the call to the user, with information as to which account is carrying the call via ringtone, screen text or color, or vibration. The user may accept to place the first call on hold and accept the second by standard procedures, sending a Hold message using the Transaction Identifier or radio channel associated with the first call. A Call Accepted message is sent using the Transaction Identifier or radio channel associated with the account of the waiting channel. Alternatively the user may choose to reject the call, sending a Disconnect using the Transaction Identifier or radio channel of the waiting call.

### Conference (Three-Way) Call

When a call is in progress, another party may be added to the call, using services in the telephone network system. For example, in the Call Waiting scenario presented above, the user may elect to join the callers in a three-way conversation. If the two calls are on the same account, this is handled just as in today's single account phones, transparent to the network, by sending the appropriate supplementary service commands. When a second call is made or received, the user will be offered options to toggle between calls, terminate either one, or to join them in a three way call. Conferencing two calls on different accounts may require changes to the network infrastructure. In situations where it is not possible, the user will not be offered a three-way option.

### Outgoing Call

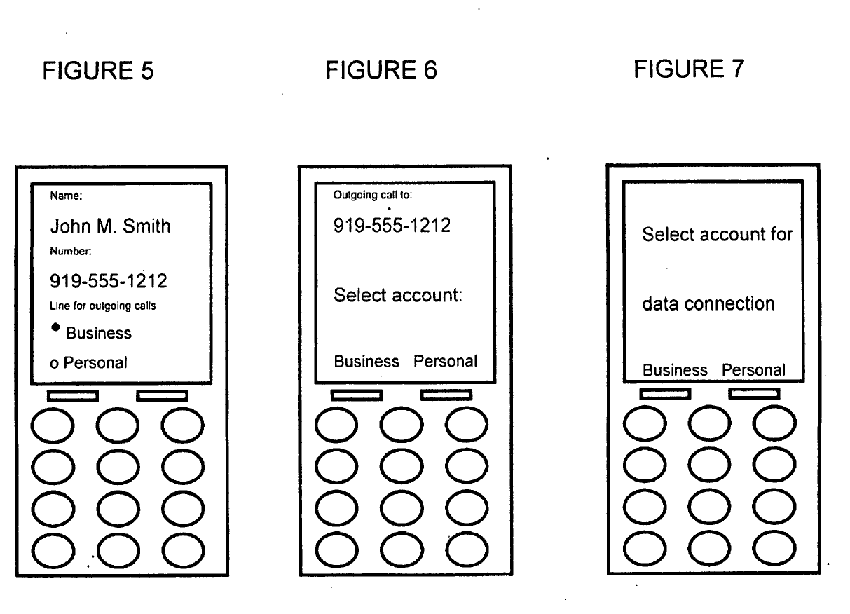

The user must identify which account is to be used for each outgoing call. For convenience, each entry in the user's dialing directory (phonebook) and speed-dial list can include a preferred account to be used as shown in FIG. 5. This account will be used when the call recipient is selected from the dialing directory or via speed-dial. When the user enters a number directly from the keypad and selects “Send”, he will be offered the list of accounts and may select one as shown in FIG. 6. Other user interface schemes are possible, but this one is preferred since it most closely matches the current paradigm. The outgoing call signaling is handled similarly to that used by single-account phones.

### Voicemail

Separate voicemail mailboxes will be provided for each account. When a call is missed or rejected, the caller will be offered the appropriate mailbox and message. When the user wishes to check voicemail, a separate telephone number will be available for each mailbox. Common practice is to press and hold “1” for an extended interval to reach one's voice mailbox. This user interface may be extended in either of two way while remaining close to the expected paradigm. Pressing “1” could present the user with a list of accounts, from which the appropriate one is selected. Alternatively, each voice mailbox could be assigned to a separate key, “1”, “2”, etc.

### Call Log

The Call Log lists completed and uncompleted outgoing and incoming calls. It's sometimes convenient to highlight a call in the log and press “Send” to reach that person. The log in a multi-account phone will also contain an indicator of the account the call is associated with. This information will be displayed and will be used for account selection when a log entry is selected to make an outgoing call.

### Text Messaging

Text Messaging, also known as Short Message Service or SMS, is a service used to send and receive short textual messages. Display of messages will indicate the account on which they were received. When a message is to be sent, the user's dialing directory will be consulted as to which account is to be used. If the recipient is not in the directory, a list will be displayed and will be used for account selection.

### Web Browsing/Internet Access/Data Services

Modern cellular telephones provide data services in one or more ways. Schemes in use include modem service, Generalized Packet Radio Services (GPRS), Enhanced Data rates for GSM Evolution (EDGE), Evolution-Data Optimized (EVDO), and High-Speed Packet Access (HSPA). The cellular telephone can be used as a web browser, a terminal for telnet or remote desktop services, or as a “modem” to connect a nearby computer to the internet over the cellular network. A multi-account cellular telephone must assure that the appropriate account is used. When data services are initiated, the user will be offered a selection dialog to use to designate the account to use for data access, as shown in FIG. 7

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a cellular telephone device having a plurality of slots for receiving SIM cards;
a plurality of SIM cards, each inserted in a corresponding one of the plurality of slots;
said plurality of SIM cards carrying encrypted data identifying a plurality of service account identities, each of said SIM cards identifying a corresponding one service identity distinct from service identities identified by others of said SIM cards;
a control element in said telephone device enabling selection of one of said plurality of service identities and effectuating operation of said telephone device under the selected service identity.

2. Apparatus according to claim 1 wherein said telephone device has a plurality of non-interfering transmitter/receiver components, each associated with a corresponding one of said slots.

3. Apparatus according to claim 1 wherein said telephone device has a single transmitter/receiver component.

4. Apparatus according to claim 1 wherein said telephone device has two SIM card slots and further wherein the number of SIM cards is two.

5. Apparatus according to claim 1 wherein said telephone device, on powering on, initializes service for each of the plurality of service accounts, registering the different accounts in succession.

6. Apparatus according to claim 1 wherein said control element responds to an incoming call on an active account service by selecting the corresponding service identity and indicating to the user the service identity for which the call is incoming.

7. Apparatus according to claim 6 wherein the indication to the user of the selected service identity is selected from the group consisting of a screen display, a distinctive ring tone, or a distinctive vibration.

8. Apparatus according to claim 1 wherein said control element responds to an incoming call on a second active account service during active use of the telephone device in a call on a first active account service by indicating to the user the second service identity for which the call is incoming.

9. Apparatus according to claim 8 wherein the indication to the user of the second service identity is selected from the group consisting of a screen display, a distinctive ring tone, or a distinctive vibration.

10. Apparatus according to claim 1 wherein said control element enables user selection of one of said plurality of service identities for effectuating an originated call.

11. Apparatus according to claim 1 further comprising a call logging component in said telephone device and wherein said call logging component separately logs activity in each of the plurality of service identities.

12. Apparatus according to claim 1 further comprising a short message service component in said telephone device and wherein said short message service component distinguishes among the plurality of service identities.

13. Apparatus according to claim 12 wherein said short message service component indicates to the user the service identity for which a message is incoming.

14. Apparatus according to claim 13 wherein the indication to the user of the service identity is selected from the group consisting of a screen display, a distinctive ring tone, or a distinctive vibration.

15. Apparatus according to claim 13 wherein said short message service component enables user selection of one of said plurality of service identities for effectuating an originated message.

16. Apparatus according to claim 1 wherein said telephone device is enabled for data transfer and further wherein said control element enables user selection of one of said plurality of service identities for effectuating a data transfer call.

17. Method comprising:
turning on a cellular telephone instrument which has a plurality of SIM cards inserted into a plurality of card slot provided in the instrument, the plurality of SIM cards carrying encrypted data identifying a plurality of service account identities, each of said SIM cards identifying a corresponding one service identity distinct from service identities identified by others of said SIM cards;
initializing service for each of the plurality of service accounts;
registering the different accounts in succession;
selecting one of the plurality of service identities and effectuating operation of said telephone device under the selected service identity.

18. Method according to claim 17 wherein the selecting is performed by a user initiating use of one of the service identities.

19. Method according to claim 17 wherein the selecting precedes initiation of a outgoing call.

20. Method according to claim 17 wherein the selecting follows reception of an incoming call.
